(19) United States
(12) Patent Application Publication
(10) Pub. No.: US 2020/0215565 A1
(43) Pub. Date: Jul. 9, 2020

(54) METHOD AND APPARATUS FOR INLINE COATING OF SUBSTRATES

(71) Applicant: Adam ZAX, Capistrano Beach, CA (US)

(72) Inventors: Adam ZAX, Capistrano Beach, CA (US); Roger EKHOLM, JR., Fallbrook, CA (US)

(21) Appl. No.: 16/827,007

(22) Filed: Mar. 23, 2020

Related U.S. Application Data
(63) Continuation-in-part of application No. 15/921,411, filed on Mar. 14, 2018.

(51) Int. Cl. B05C 9/04; B05B 13/02; B05D 1/02

(52) U.S. Cl. CPC B05C 9/04; B05D 1/02; B05B 13/0221

(57) ABSTRACT

A coating apparatus that can coat a substrate while assuring a volatile organic compound (VOC) free atmosphere outside the equipment. The coating apparatus can be used in-line, where flat materials and substrates that are typically carried along a conveyer may enter the coating apparatus without requiring the substrate to be moved into any other configuration. The coating apparatus may be configured to permit the user to perform any number of treatment steps while providing isolation between the steps. The coating apparatus can be formed by nesting one or more inner chambers inside a central chamber which may be nested inside an outer chamber. The outer chamber may be, for example, a vacuum chamber to ensure removal of VOCs.

### CROSS-REFERENCE TO RELATED APPLICATION

This application is a continuation-in-part of U.S. patent application Ser. No. 15/921,411, filed Mar. 14, 2018, the contents of which are herein incorporated by reference.

### BACKGROUND OF THE INVENTION

### 1. Field of the Invention

Embodiments of the invention relates generally to methods and apparatus for coating substrates. More particularly, the invention relates to methods and apparatus that can concurrently coat both sides of a variety of flat materials and substrates inline while assuring a volatile organic compound (VOC) free atmosphere outside of the equipment.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Existing methods and equipment for coating substrates only provide surface preparation coating on one side of materials, such as plate glass or sheet metal. Coating the opposite side requires a secondary process. Additionally, existing methods require the flat sheet or substrate to be in a vertical position to accomplish coating. As most manufacturing lines transport flat sheets or substrates in a horizontal mode, this requires the additional step of transitioning the product from a horizontal to a vertical presentation. In the majority of cases, this must be done manually, adding to cost and labor for the coating process.

In view of the foregoing, there is a need for improved methods and apparatus for the inline coating of a substrate while having the ability to coat both front and back sides of the substrate at the same time.

### SUMMARY OF THE INVENTION

Embodiments of the present invention provide a coating apparatus comprising a lower assembly comprising an infeed belt configured to receive a substrate and direct the substrate to a treatment zone, a lower distribution plate having a substrate facing side facing the substrate when the substrate is positioned in the treatment zone, and one or more lower coating distributors adapted to deliver a treatment to the substrate while the substrate passes through the treatment zone, wherein the lower distribution plate is located vertically below a plane defined by the infeed belt and the substrate is suspended above the lower distribution plate as the substrate passes through the treatment zone; and an upper assembly comprising an upper distribution plate having a substrate facing side facing the substrate and spaced a distance away from the substrate when the substrate is positioned in the treatment zone, and one or more upper coating distributors adapted to deliver the treatment to the substrate while the substrate passes through the treatment zone.

Embodiments of the present invention further provide a coating apparatus comprising a lower assembly comprising an infeed belt configured to receive a substrate and direct the substrate to a treatment zone, a lower distribution plate having a substrate facing side facing the substrate when the substrate is positioned in the treatment zone, one or more lower coating distributors adapted to deliver a treatment to the substrate while the substrate passes through the treatment zone, and at least lower one vacuum opening in the lower distribution plate configured to remove vapor from the treatment zone, wherein the lower distribution plate is located vertically below a plane defined by the infeed belt and the substrate is suspended above the lower distribution plate as the substrate passes through the treatment zone; and an upper assembly comprising an upper distribution plate having a substrate facing side facing the substrate and spaced a distance away from the substrate when the substrate is positioned in the treatment zone, an infeed roller sandwiching the substrate between the infeed belt and the infeed roller, one or more upper coating distributors adapted to deliver the treatment to the substrate while the substrate passes through the treatment zone, and at least upper one vacuum opening in the upper distribution plate configured to remove vapor from the treatment zone, wherein the upper assembly is vertically spaced apart from the lower assembly by a separation distance, where the separation distance is adjustable based on a thickness of the substrate.

Embodiments of the present invention also provide a method of treating a substrate comprising moving the substrate horizontally along a conveyor; receiving the substrate on an infeed belt of a lower assembly of a coating apparatus; suspending the substrate above a distribution plate of the lower assembly; delivering a treatment to the substrate via one or more lower coating distributors while the substrate passes through a treatment zone defined as a region adjacent the distribution plate; wherein the coating assembly includes an upper assembly having an upper distribution plate having a substrate facing side facing the substrate and spaced a distance away from the substrate when the substrate is positioned in the treatment zone; and one or more upper coating distributors adapted to deliver the treatment to the substrate while the substrate passes through the treatment zone.

Embodiments of the present invention further provide a coating apparatus comprising a substrate guide for directing a substrate through the coating apparatus; at least one inner chamber housing having a closed top with side members extending from the closed top to terminate at an open inner chamber bottom thereof, the open inner chamber bottom positioned adjacent the substrate when the substrate passes under the at least one inner chamber housing; at least one inner chamber connector disposed on each of the at least one inner chamber housing, the at least one inner chamber connector providing a first treatment to an interior of the inner chamber housing; an outer chamber housing nested over all of the at least one inner chamber housing, the outer chamber housing having a closed top with side members extending from the closed top to terminate at an open outer chamber bottom thereof, the open outer chamber bottom positioned adjacent the substrate about an outer periphery of each of the at least one inner chamber housing when the substrate passes under the outer chamber housing; and at least one outer chamber connector disposed on each of the at least one outer chamber housing, the at least one outer chamber connector providing a second treatment from outside the outer chamber housing to an interior of the outer chamber housing.

Embodiments of the present invention further provide a coating apparatus for applying a treatment to a substrate, comprising at least one inner chamber housing having a closed top with side members extending from the closed top to terminate at an open inner chamber bottom thereof, the open inner chamber bottom positioned adjacent the substrate when the substrate passes under the at least one inner chamber housing; at least one inner chamber connector disposed on each of the at least one inner chamber housing, the at least one inner chamber connector providing a first treatment to an interior of the inner chamber housing; at least one central chamber housing nested over all of the at least one inner chamber, the at least one central chamber having a closed top with side members extending from the closed top to terminate at an open chamber bottom thereof, the open central chamber bottom positioned adjacent the substrate about an outer periphery of each of the at least one inner chamber housing when the substrate passes under the central chamber housing; at least one central chamber connector disposed on each of the at least one central chamber housing, the at least one central chamber connector providing a second treatment to the interior of the central chamber housing; an outer chamber housing nested over all of the at least one central chamber housing, the outer chamber housing having a closed top with side members extending from the closed top to terminate at an open outer chamber bottom thereof, the open outer chamber bottom positioned adjacent the substrate about an outer periphery of each of the at least one central chamber housing when the substrate passes under the outer chamber housing; at least one outer chamber connector disposed on each of the at least one outer chamber housing, the at least one outer chamber connector providing a third treatment from outside the outer chamber housing to an interior of the outer chamber housing; a plurality of through holes in the outer chamber housing to provide a means to deliver the second treatment to the central chamber connector and to deliver the first treatment to the interior of each of the at least one inner chamber housing; and at least one central chamber through hole in the central chamber housing to provide a means to deliver the first treatment to the interior of each of the at least one inner chamber housing.

Embodiments of the present invention further provide a method of treating a substrate comprising passing a substrate through a first treatment zone within an outer chamber housing, the outer chamber housing having a closed top with side members extending from the closed top to terminate at an open outer chamber bottom thereof, the open outer chamber bottom positioned adjacent the substrate; providing a first treatment within the outer chamber housing via at least one outer chamber connector disposed on the outer chamber housing; passing the substrate through at least one inner chamber housing having a closed top with side members extending from the closed top to terminate at an open inner chamber bottom thereof, the open inner chamber bottom positioned adjacent the substrate when the substrate passes under the at least one inner chamber housing, the at least one inner chamber housing nested within the outer chamber housing; and providing a second treatment within the at least one inner chamber housing via at least one inner chamber connector disposed on the inner chamber housing.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1A illustrates a top perspective view of a coating apparatus according to an exemplary embodiment of the present invention;

FIG. 1B illustrates a side perspective view of the coating apparatus of FIG. 1A;

FIG. 1C illustrates a top view of the coating apparatus of FIG. 1A, showing an exemplary tubing connection configuration;

FIG. 2 illustrates a side view of the coating apparatus of FIG. 1A, showing the upper assembly in a raised configuration;

FIG. 3 illustrates a top view of the coating apparatus of FIG. 1A;

FIG. 4A illustrates top perspective view an upper assembly of the coating apparatus of FIG. 1A;

FIG. 4B illustrates a side perspective view of the upper assembly of FIG. 4A;

FIG. 5 illustrates a side view of the upper assembly of FIG. 4A;

FIG. 6 illustrates a top view of the upper assembly of FIG. 4A;

FIG. 7 illustrates an end view of the upper assembly of FIG. 4A;

FIG. 8 illustrates a bottom view of the upper assembly of FIG. 4A;

FIG. 9A illustrates a top perspective view of a distribution plate used in the upper assembly shown in FIG. 4A;

FIG. 9B illustrates a bottom, substrate facing, perspective view of the distribution plate of FIG. 9A;

FIG. 10 illustrates a bottom perspective view of a lower assembly of the coating apparatus of FIG. 1A;

FIG. 11 illustrates a top, substrate facing, perspective view of the lower assembly of FIG. 10;

FIG. 12 illustrates a side perspective view of the lower assembly of FIG. 10;

FIG. 13 illustrates a side perspective view of the lower assembly of FIG. 10, showing a substrate passing therethrough;

FIG. 14 illustrates a chemical introduction system according to an exemplary embodiment of the present invention;

FIG. 15 illustrates details of a seal system for use with the chemical introduction system of FIG. 14;

FIG. 16 illustrates a perspective view of a coating apparatus according to an exemplary embodiment of the present invention;

FIG. 17 illustrates a top view of the coating apparatus of FIG. 16;

FIG. 18 illustrates a perspective view of an outer chamber cover of the coating apparatus of FIG. 16;

FIG. 19 illustrates a perspective view of the outer chamber cover of the coating apparatus of FIG. 16;

FIG. 20 illustrates a perspective view of the coating apparatus of FIG. 16 with the outer chamber cover removed;

FIG. 21 illustrates a top view of the coating apparatus of FIG. 16 with the outer chamber cover removed;

FIG. 22 illustrates a perspective view of a central chamber cover of the coating apparatus of FIG. 16;

FIG. 23 illustrates a perspective view of the central chamber cover of the coating apparatus of FIG. 16;

FIG. 24 illustrates a perspective view of the coating apparatus of FIG. 16 with the outer and central chamber covers removed;

FIG. 25 illustrates a detailed perspective view of the coating apparatus of FIG. 16 with the outer and central chamber covers removed;

FIG. 26 illustrates a perspective view of one of the inner chamber covers of the coating apparatus of FIG. 16;

FIG. 27 illustrates a perspective view of the inner chamber cover of the coating apparatus of FIG. 16;

FIG. 28 illustrates a perspective view of the coating apparatus of FIG. 16 with the outer, central and inner chamber covers removed;

FIG. 29 illustrates a detailed perspective view of the coating apparatus of FIG. 16 with the outer, central and inner chamber covers removed; and

FIG. 30 illustrates a cross-sectional view taken along line XXX-XXX of FIG. 16.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

A description of an embodiment with several components in communication with each other does not imply that all such components are required. On the contrary, a variety of optional components are described to illustrate the wide variety of possible embodiments of the present invention.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a coating apparatus that can be used to concurrently coat both sides of a substrate while assuring a VOC free atmosphere outside the equipment. The coating apparatus can be used in-line, where flat materials and substrates that are typically carried along a conveyer may enter the coating apparatus without requiring the substrate to be moved into any other configuration. The coating apparatus may be configured to permit the user to perform any number of treatment steps while providing isolation between the steps. The substrate can be partially suspended by the coating apparatus to permit both sides to be treated at the same time. A vacuum system, including redundant perimeter negative pressure venting ducts, can create a vacuum perimeter wall around the moving, treated material to ensure a VOC free atmosphere outside the coating apparatus.

Embodiments of the present invention further provide a coating apparatus that can coat a substrate while assuring a VOC free atmosphere outside the equipment. The coating apparatus can be used in-line, where flat materials and substrates that are typically carried along a conveyer may enter the coating apparatus without requiring the substrate to be moved into any other configuration. The coating apparatus may be configured to permit the user to perform any number of treatment steps while providing isolation between the steps. The coating apparatus can be formed by nesting one or more inner chambers inside a central chamber which may be nested inside an outer chamber. The outer chamber may be, for example, a vacuum chamber to ensure removal of VOCs.

The methods described herein for material handling and coating may be performed in a relatively compact area, typically along a conveyor moving the substrate. A short span in required for multiple step treatments of a substrate. For example, as described in greater detail below, a coating apparatus may have a length, from an input end to an output end, of about three feet and such an apparatus may be used to perform a continuous, in-line, four-step coating of substrates entering the apparatus at from about 10 seconds per foot of substrate to about 1 second per foot of substrate.

The short span that is required for these multiple steps allows the equipment to partially suspend the flat sheet to be treated, resulting in full access to both sides at the same time. This can be accomplished by feed rollers that suspend the substrate in the enclosed treatment zones. Once treated, the substrate can be moved to take away feed rollers to move the substrate out of the treatment zones and onto further plant processing.

As discussed in greater detail below, chemical fumes, such as VOCs, are captured on an inline basis, assuring no operator exposure to potentially damaging chemical fumes. This may be accomplished by using redundant perimeter negative pressure venting ducts designed with very narrow slits to create a high vacuum perimeter wall around the moving, treated material. An interior set of ducts can remove the majority of the process fumes while the outside, secondary set can perform a clean-up function, to assure no fumes escape the apparatus.

As used herein, the term “substrate” refers to any material, typically a flat material, that may be treated by the coating apparatus of the present invention. A substrate can include, as non-limiting examples, plate glass, sheet metal, rigid plastic plates, or the like.

As used herein, the term “coatings” refers to any treatment that may be applied to the substrate by the coating apparatus of the present invention. A coating can be a vapor state coating, a liquid state coating or some other surface modification treatment such as ultraviolet light treatment, radiation treatment, plasma treatment, or the like. The term “treatment” may refer to any method that chemically or physically changes the substrate, any method that chemically or physically interacts with a previous application to the substrate, or any method that prepares the substrate for a subsequent chemical or physical change, such as a method that applies a catalyst to the substrate or reacts with a catalyst previously applied to the substrate.

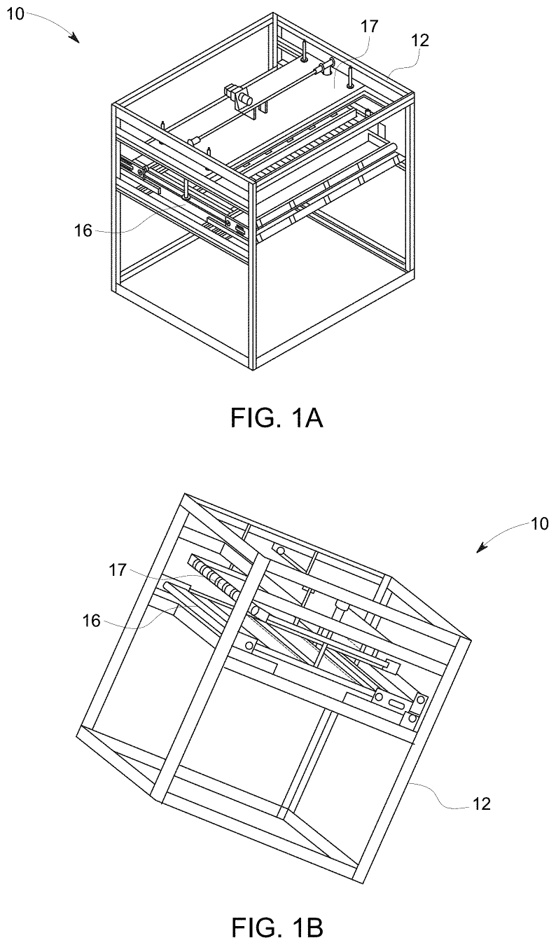

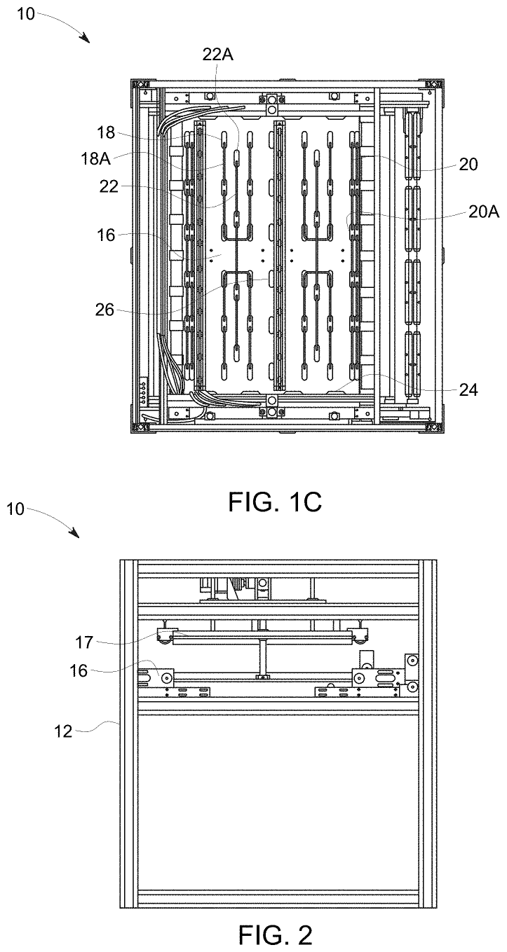

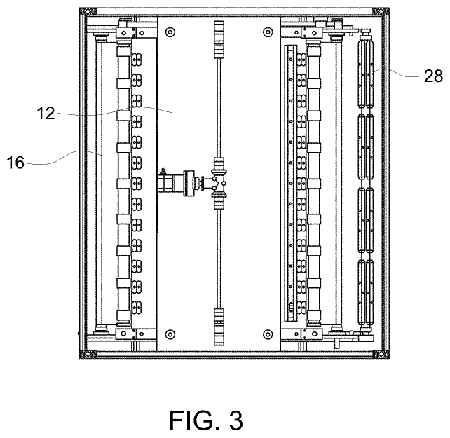

Referring now to FIGS. 1A through 3, a coating apparatus 10 can include a frame structure 12 adapted to support an upper assembly 14 and a lower assembly 16. As discussed in greater detail below, at least one of the upper assembly 14 and the lower assembly 16 may be movable vertically, relative to the frame structure 12. For example, the lower assembly 16 may be moved to a suitable height to receive a substrate, and the upper assembly 14 may be moved relative to the lower assembly 16 depending on a thickness of the substrate being coated.

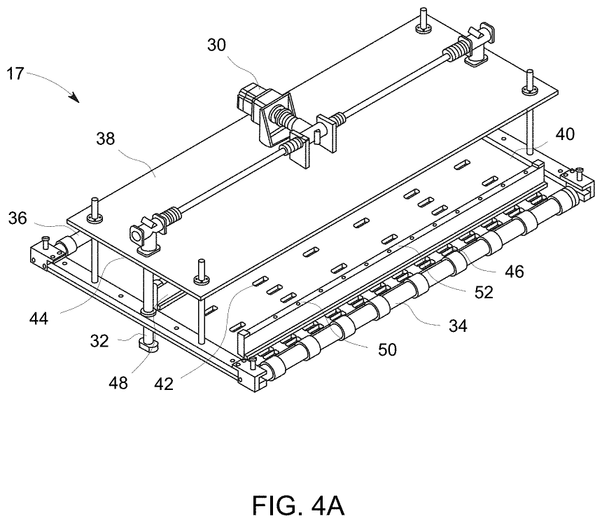

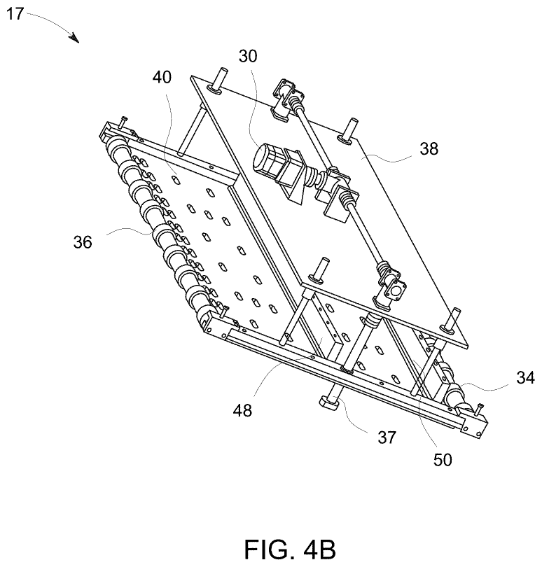

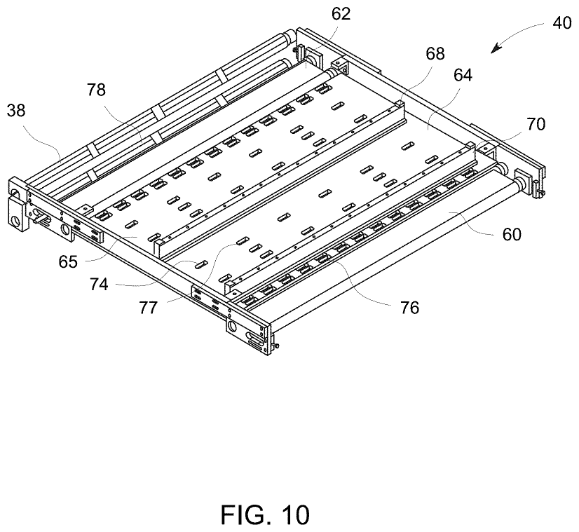

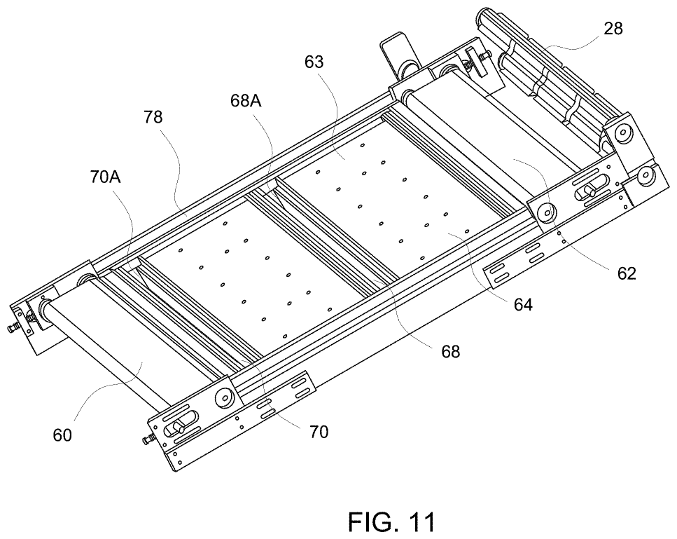

Each of the upper assembly 14 and the lower assembly 16 can include a distribution plate 40, 64, as shown in FIGS. 4A and 10, for example, that can be used to communicate a coating, a gas, a vacuum, or the like, into a treatment zone 15 located between the distribution plates 40, 64. For example, in some embodiments, as shown in FIG. 1C, coating application tubing 18 may be used to carry coating to coating distributors 18A, also referred to as coating nozzles 18A, or simply nozzles 18A, perimeter vacuum tubing 20 may be used to provide suction to vacuum nozzles 20A and interior vacuum tubing 22 may be used to provide suction to interior vacuum nozzles 22A. In addition, side perimeter nozzles 24 may be used to provide a vacuum along the sizes of the treatment zone 15 and zone separation nozzles 26 may be used to separate treatment regions within the treatment zone 15, as discussed in greater detail below. Of course, the above describes only one possible configuration, using a specific number of nozzles 18A, 20A, 22A, 24 and 26. The configurations of the nozzles, including location, number and density of the nozzles, for example, can be altered from that shown in the figures depending on the particular application.

Various treatments of the vacuumed vapor may be performed, as needed, prior to release. These treatments may include the removal of VOCs, or depending on treatment, acid scrubbers, neutralization of vapors, or removal of any controlled emission. In some embodiments, the various vacuum tubing may pass through a condensation zone to recover vaporized liquids, including unreacted treatment chemical which may be subsequently purified, as needed, and reused as appropriate.

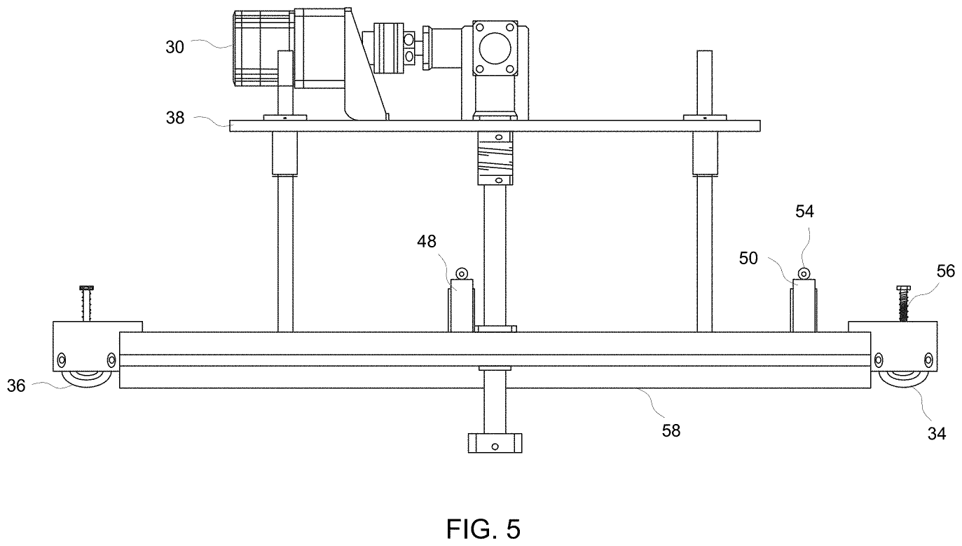

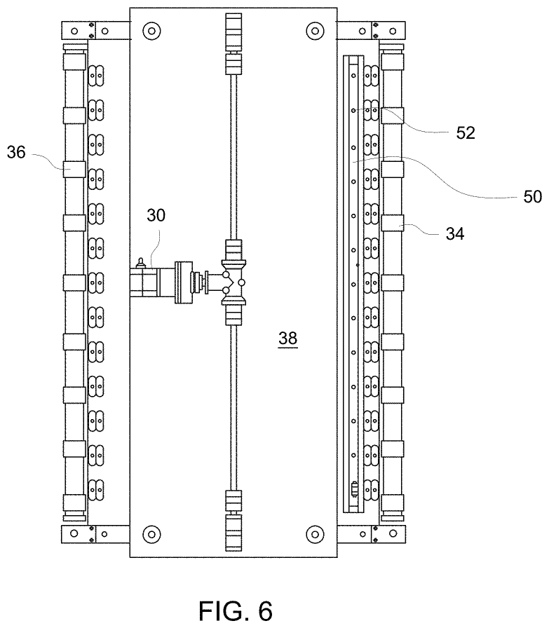

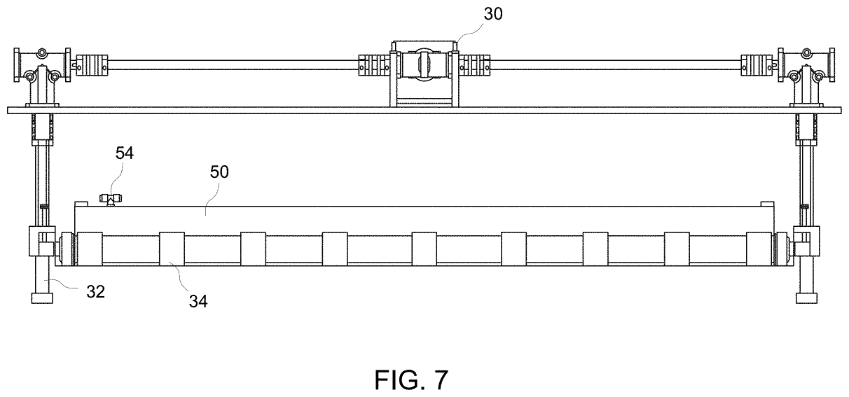

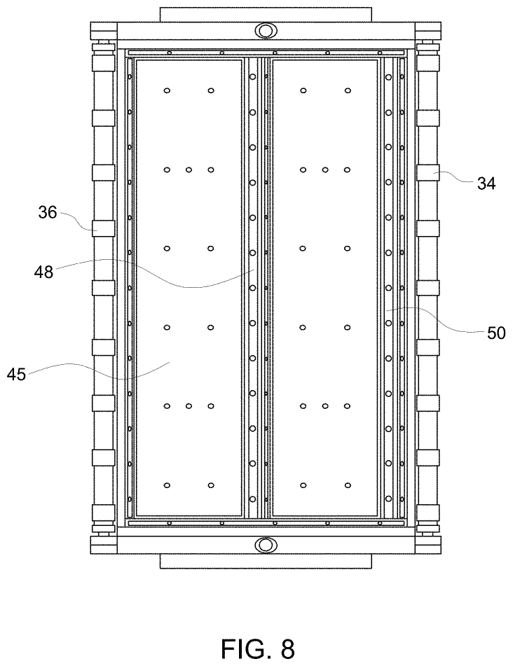

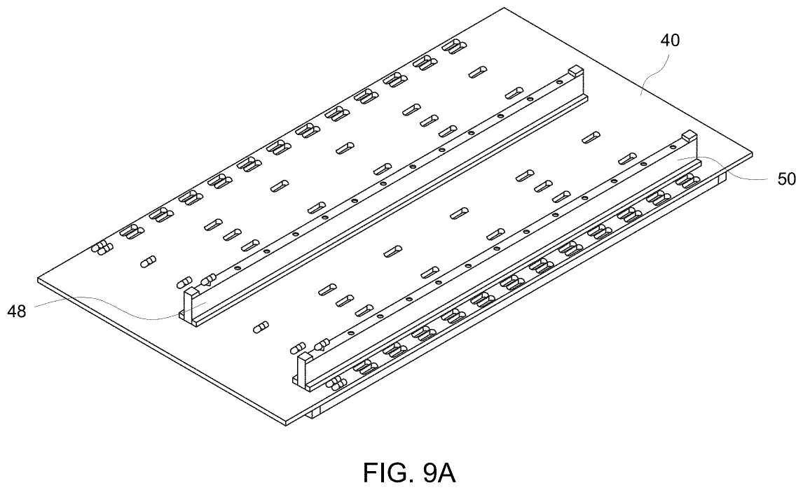

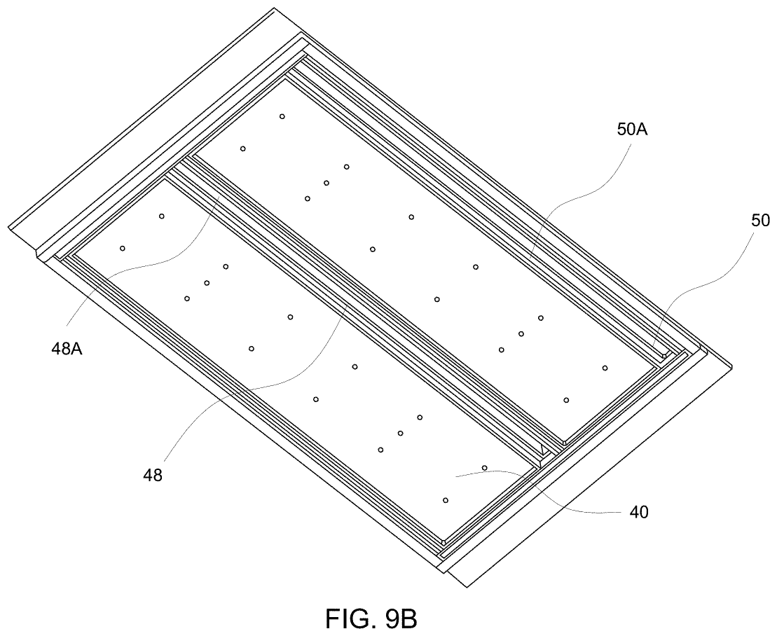

Referring to FIGS. 4A through 9B, the upper assembly 14 is shown in detail. A height adjustment system can include a servo 30 mounted on a height adjustment system plate 38 to permit the height of the distribution plate 40 to adjust relative to the lower assembly 12 (see FIG. 1B). Height adjustment legs 32 may support the distribution plate 40 at the desired height. The height adjustment system may operate via a switch (not shown) or may include sensors for automatically adjusting the height based on a thickness of a plate to be treated by the coating assembly 10.

The upper assembly 14 can include an infeed roller 34 and an outfeed roller 36 to help guide the substrate into and out of the treatment zone 15 (see FIG. 1B). An adjustment screw 56, or other similar structure, may be used to adjust the position of the infeed and outfeed rollers 34, 36. In some embodiments, as may be known in the art, the infeed and outfeed rollers 34, 36 may be resiliently movable upward (away from the substrate passing through the coating apparatus 10) to permit the substrate to enter the treatment zone 15.

The distribution plate 40 may have a plurality of openings 42 into which a coating distributor 44, also referred to as a nozzle 44 may be disposed. The placement of the openings 42, the type of nozzles 44 and the treatment provided thereby may vary depending upon the desired application. In some embodiments, a distribution manifold 48, 50 may be disposed to provide a cavity 48A, 50A accessible from a bottom side 45 (or substrate facing side 45) of the distribution plate 40. One or more coating distributors 54, also referred to as nozzles 54, may be disposed on a top side of the distribution manifolds 48, 50. The distribution manifolds 48, 50 may provide an increased spacing between the nozzles 54 and the substrate as compared to the nozzles 44 disposed directly in the openings 42 of the distribution plate 40. Such increased spacing may be useful for certain treatments. For example, to provide an atomized water treatment on the substrate, the distribution manifolds 48, 50 may be used to create an even and uniform coating of water on the substrate.

In some embodiments, an outer periphery of the distribution plate 40 may include a set of two openings 46 arranged adjacent to each other. Such sets of openings 46 may be useful to provide, for example, a vacuum about the treatment zone 15 to prevent fumes (such as those from treatments applied via nozzles 44 through the openings 42) from escaping the coating apparatus 10.

In some embodiments, side members 58 may extend below a plane of the distribution plate 40. The side members 58 may help enclose the treatment zone 15 to prevent the escape of fumes.

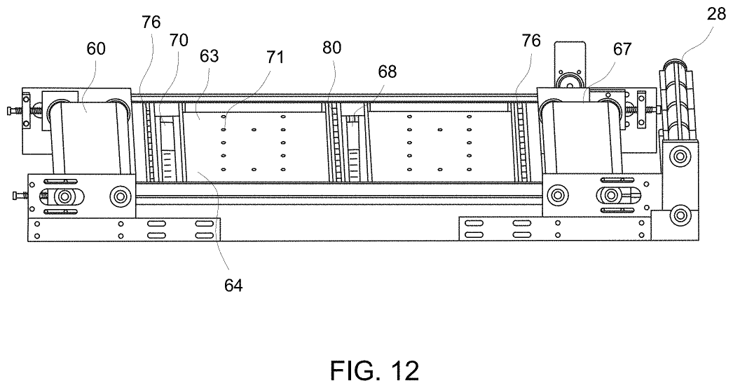

Referring to FIGS. 10 through 12, the lower assembly 16 is described in greater detail. The lower assembly 16 can include an infeed belt 60 and an outfeed belt 62. In some embodiments, at least one or both of the infeed belt 60 and the outfeed belt 62 are driven to move the substrate through the treatment zone 15 (see FIG. 1B), where the substrate may be suspended above the top side 65 (also referred to as the substrate facing side 65) of the distribution plate 64. While a belt having a certain length is shown for the infeed and outfeed belts 60, 62, these items may be designed in various manners, such as one or more rollers, multiple belts, or the like.

In some embodiments, the distribution plate 64 of the lower assembly 16 may be a mirror image of the distribution plate 40 of the upper assembly 14. In other words, the distribution openings 42 of the distribution plate 40 may align vertically with distribution openings 72 and coating distributors 74, also referred to as nozzles 74, of the lower assembly 16. Similarly, the tubing distributions, such as those shown in FIG. 1C, may be the same for both the distribution plate 40 and the distribution plate 64. Such a configuration permits the concurrent treatment of both sides of the substrate in an identical manner. Of course, in some embodiments, treatment of one side of the substrate may be performed with one type of coating, while treatment of the other side of the substrate may be performed with a different type of coating. The coating apparatus 10 of the present invention permits such features depending on the tubing configuration, type of nozzle, distribution opening arrangement, and the like.

Similar to the distribution plate 40 of the upper assembly 14, as described above, the distribution plate 64 of the lower assembly 16 can include one or more distribution manifolds 68, 70 that can provide a chamber 68A, 70A allowing a nozzle to be located a distance away from the substrate facing side 65 of the distribution plate 64. Further similar to the distribution plate 40 of the upper assembly 14, the distribution plate 64 of the lower assembly 16 can include a double row of adjacent openings 76 that may be disposed about the outer periphery of the distribution plate 64. A vacuum may be applied to these openings 76 to create a wall to prevent escape of fumes from the coating apparatus 10.

Side walls 78 of the lower assembly 16 may be aligned with side walls 58 of the upper assembly 14. The side walls 78 may extend above a plane of the distribution plate 64 to approach or contact the side members 58 of the upper assembly 14 may help enclose the treatment zone 15 to prevent the escape of fumes.

In some embodiments, a polishing wheel 28 may be provided on an outfeed side (adjacent outfeed belt 62) of the lower assembly 14. The polishing wheel 28 may take various configurations. For example, as shown in the Figures, the polishing wheel 28 may include upper and lower brushes that turn to contact the substrate as it exits the treatment zone 15. The polishing wheel 28 may be used to remove by-products of the treatment performed by the coating apparatus 10.

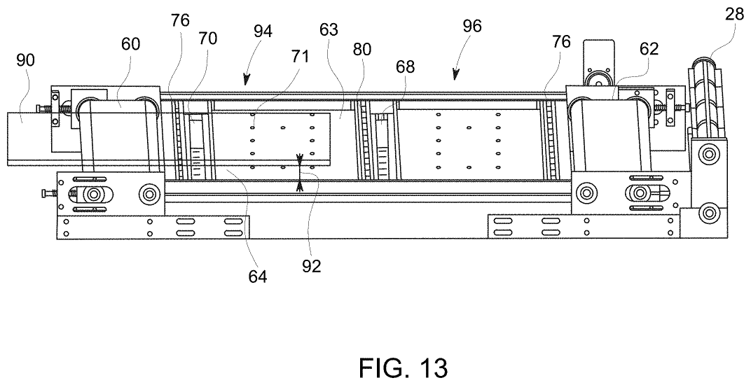

Referring now to FIGS. 1C, 2, 8 and 13, one example of substrate treatment is described. In this case, the substrate may be a plate glass member 90 (shown in FIG. 13 with the upper assembly 14 and the frame 12 not shown for clarity). The plate glass member 90 may be moved by infeed belt 60 into a first treatment zone 94. The plate glass member 90 may be suspended from the distribution plate 64 by a distance 92. Similarly, the upper assembly 16 may be lowered so that the distribution plate 40 is separated from the plate glass member 90 by a similar distance as the distance 92. A first one of the distribution manifolds 50, 70 may be configured to provide a water coating on the substrate. This may be performed by atomizing water as discussed above, or by any other means known in the art, such as a via a brush, sponge, or the like.

Tubing 18 may provide a first treatment coating via nozzles 18A in the first treatment zone 94. Vacuum may be applied by vacuum tubing 22, via vacuum nozzles 22A as a primary source of fume removal from the first treatment zone 94. As discussed above, vacuum nozzles may be provided about a perimeter of the distribution plates 40, 64 to further remove any excess of the first treatment coating provided through the nozzles 18A. A set of separation nozzles 26 may be provided at the end of the first treatment zone 94. In some embodiments, air may be provided through the separation nozzles 26 to provide an air knife. In other embodiments, vacuum may be provided through the separation nozzles 26. In either embodiment, this zone is to help separate and prevent cross-contamination from the first treatment zone 94 to a second treatment zone 96.

In the second treatment zone 96, a similar treatment may be performed, with a water coating followed by the same or different treatment coating.

As discussed above, a plurality of treatment zones may be aligned end to end to treat a substrate with multiple of the same or different treatments. Each treatment zone may be separated by separation nozzles as described above. In some embodiments, where the distance from the infeed belt and the outfeed belt is longer than a length of the substrate, supports may be added along the treatment zone to support the substrate a predetermined distance from the distribution plates.

While the term “nozzles” is used to describe a location and/or apparatus that provides an output of a coating and/or for receiving a vacuum, nozzles may describe any opening that permits the flow of a liquid or gas or that may direct a light, radiation, plasma, or the like toward the substrate. Nozzles may include any of the coating distributors as herein described. The nozzles may be directed in one or more directions, may be narrowed to create a stream of liquid or gas flow, may be elongated slits or pin point openings, or may include any variation for the delivery of liquid or gas as may be understood by one skilled in the art. The term nozzles may include any additional elements, such as UV lamps, plasma generators, or the like, that are required for the specific application.

Of course, the above is just one example of how the coating apparatus 10 may be used. Other reagents, coatings, combinations or the like may be performed. While the figures show two treatment zones 94, 96 making up the coating apparatus 10, permitting, in this case, up to four distinct treatment steps, other configurations may be contemplated within the scope of the present invention. For example, only one treatment zone 94 may be provided, or additional treatment zones may be provided. In some embodiments, a treatment zone may include the introduction of more than one treatment coating, if desired.

The coating apparatus 10 may be disposed on a conveyor designed to carry substrate in a horizontal manner. The infeed belt 60 may receive the substrate from the conveyor to introduce the substrate into the coating apparatus 10. In some embodiments, the infeed belt 60 may be configured to match the speed, or to be at least as fast as that of the conveyor, thereby preventing backup of material on the conveyor. When longer treatment times are desired, in some embodiments, the infeed belt 60 may be slower than the conveyor. In these cases, the substrate may be suitably spaced on the conveyor, or the conveyor speed adjusted, to prevent backup of material on the conveyor.

The coating apparatus 10 may be sized, not only with any number of treatment zones (in its length), but also in various widths, depending on the particular application. The coating apparatus 10 may be designed to be mobile, allowing the device to be used in various assembly lines as needed.

While the drawings depict the coating apparatus 10 configured to receive a substrate arranged horizontally, the present invention is not limited to such a configuration. For example, the frame structure 12 may be rotated 90 degrees allowing vertically arranged substrates to be treated by the coating apparatus 10. Moreover, any configuration angle for the coating apparatus 10 is contemplated within the scope of the present invention.

In some embodiments, sensors may be disposed in a location adjacent the infeed belt to determine a width of the substrate entering the coating apparatus. While FIG. 1C shows each of the nozzles 18A interconnected to nozzles 18, in some embodiments, when the width is determined to be less than the width of the treatment zone, only nozzles 18 facing the substrate may apply treatment to the substrate, while those nozzles that do not have substrate located adjacent thereto may be configured to not deliver any treatment.

An interface panel may be incorporated into the coating apparatus 10 to provide a user to adjust various parameters, including, but not limited to, infeed belt speed, treatment specifics including volume of treatment, which distributors are turned on or off, vacuum pressure/volume, and the like. The interface panel may be a touch screen mounted on the frame structure 12 or may be formed from any computing device, such as a tablet computer, smart phone, laptop, or the like, that may connect to the coating apparatus 10 via a wired or wireless connection. In some embodiments, the coating apparatus 10 may connect to a network and may be controlled via a network interface, such as, for example, via an internet-based portal. Of course, other methods for controlling the coating apparatus 10 are contemplated within the scope of the present invention. Software may be stored in the human interface, on a web-based system, or on a network computing system to provide the user with the control features, as well as other additional features, as may be understood to one skilled in the art.

Various methods may be used to deliver the treatment to the treatment zones 94, 96. As discussed above, the treatment may be a liquid treatment, a vapor treatment, a suspension, an irradiation, such as UV, or the like. When the treatment is a vapor treatment, various delivery techniques may be used. For example, those described in U.S. Pat. No. 9,562,288, the contents of which are herein incorporated by reference. In some embodiments, specially designed cartridges may be used for holding the treatment solution prior to use. When different treatment solutions are utilized, in some embodiments, a shape of the cartridges for each of the different treatment solutions may vary, where the coating apparatus may have a receptacle with a mating shape, for each of the cartridges. This helps ensure the proper treatment solution is used for each of the desired steps.

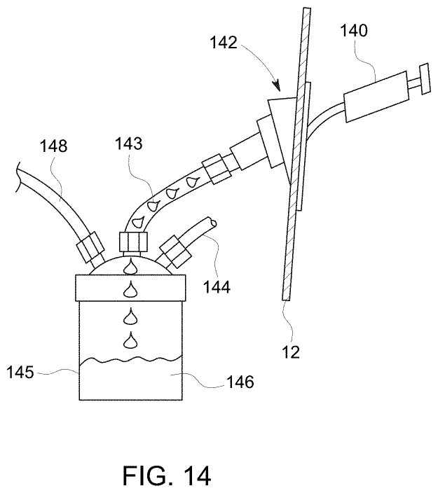

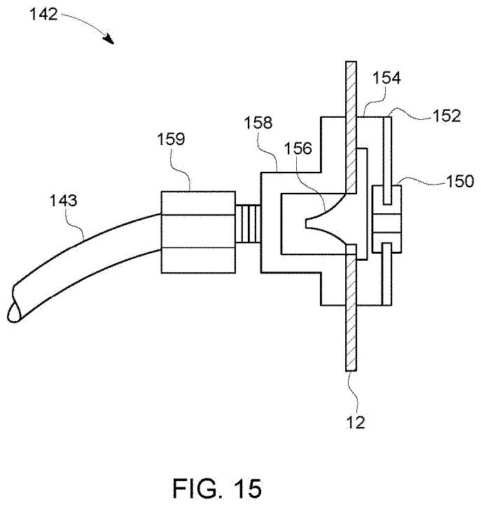

Referring now to FIGS. 14 and 15, one embodiments of a chemical introduction system is described. In this embodiment, a syringe 140, or other similar fluid transfer device, may be used to deliver solution 146 to a port 142 formed through the frame 12 of the coating apparatus 10 (see FIG. 1A). The solution may pass through a tube 143 and enter a vaporization jar 145. An inert gas, such as nitrogen, may be delivered through port 144 into the vaporization jar 145. The inert gas may be at a predetermined pressure, such as 3-10 psi, to cause the liquid in the vaporization jar 145 to vaporize and to be delivered via tube 148 to the appropriate nozzles of the coating apparatus.

Details of one embodiment of the port 142 is shown in FIG. 15. The port 142 can include a grommet 150 fitting on a sheet metal plate 152. A bulkhead can include an outer machined part 154 and an inner machined part 158 that can join together on opposite sides of the frame 12. A duckbill seal 156 may be disposed between the machined parts 154, 156 to permit the syringe 140 to pass, permitting the solution 146 to be delivered while preventing back flow of liquid or vapor to the user. A fitting, such as a compression fitting 159 may connect the tubing 143 to the port 142. As discussed above, the tubing 143 may communicate with the vaporization jar 145, where the solution 146 is stored until being delivered to the treatment zones 94, 96 (see FIG. 13).

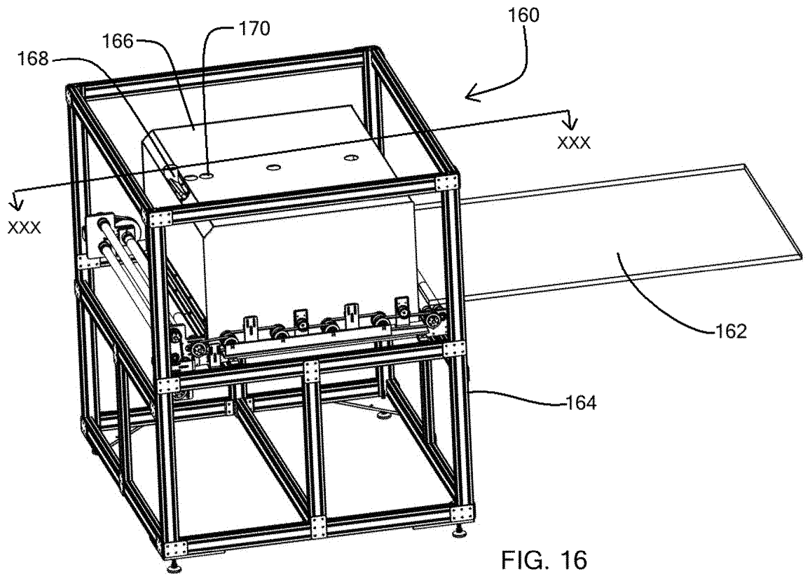

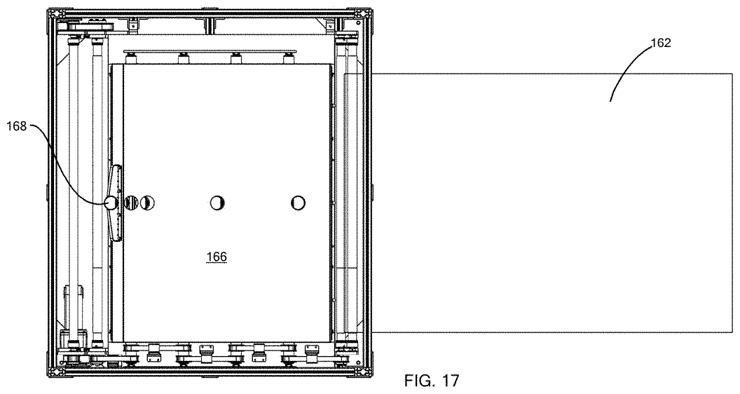

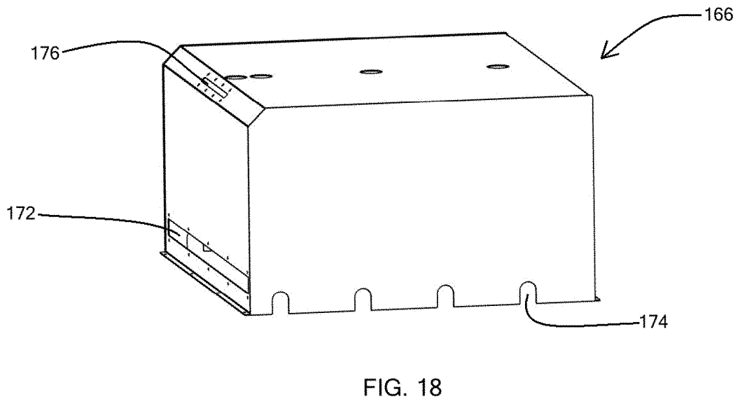

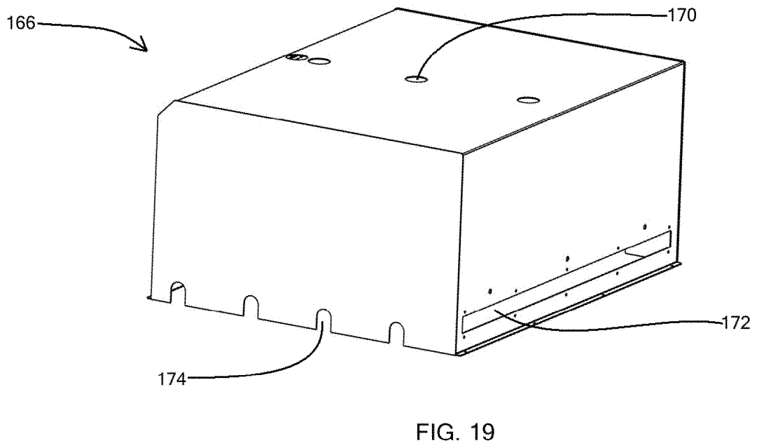

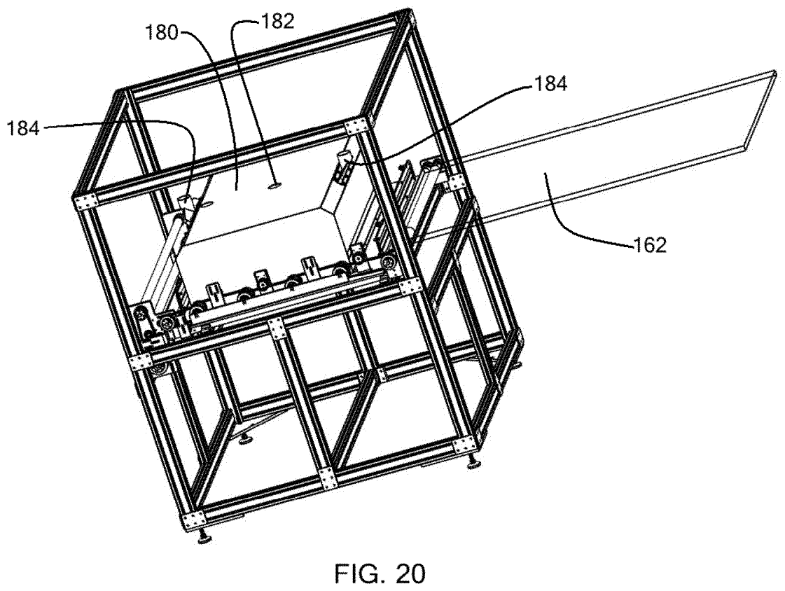

Referring now to FIGS. 16 through 19, a coating apparatus 160 can be used to coat a substrate 162, such as a plate glass substrate, for example. A frame 164 may be used to support the coating apparatus 160 at an appropriate location to receive the substrate 162. The coating apparatus 160 may include an outer chamber housing 166 that may cover interior treatment zones within the coating apparatus 160. The outer chamber housing 166 can include one or more outer chamber connectors 168 for delivery of a treatment material into the outer chamber housing 166 or to provide a vacuum to withdraw air from inside the outer chamber housing 166. An appropriate conduit, such as a flexible tubing, may be used to connect the outer chamber connector 168 with appropriate equipment for the desired application. The outer chamber housing 166 can include a plurality of openings 170 to permit access to inner chamber connectors, as described below.

The outer chamber housing 166 can include a slot 172 on each side thereof to permit the substrate 162 to move into and out of the interior of the outer chamber housing 166. The outer chamber housing 166 may further include cutout 174 to provide space for one or more rollers or other drive elements (such as a drive belt, or the like) to guide the substrate 162 through the coating apparatus 160. A mount location 176 may be provided near a top of the outer chamber housing 166 for attaching the outer chamber connector 168.

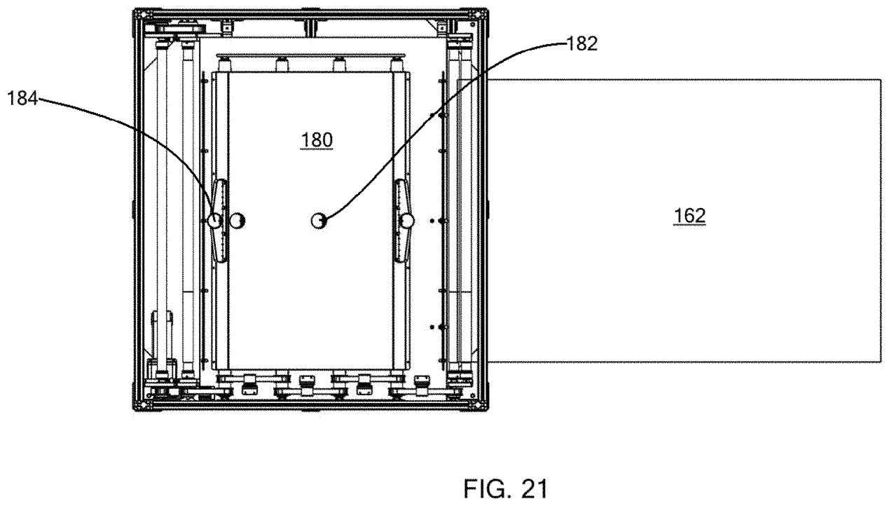

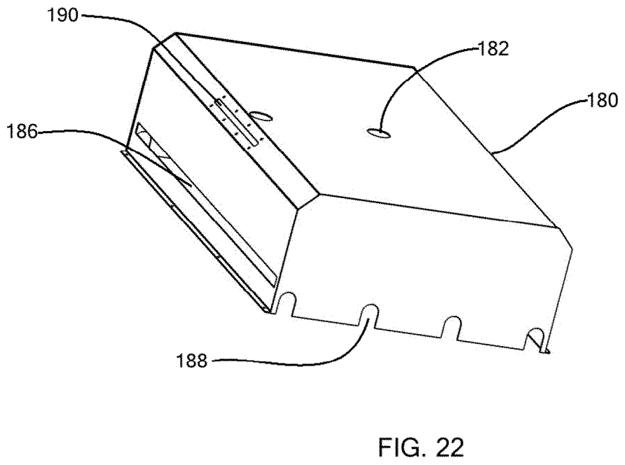

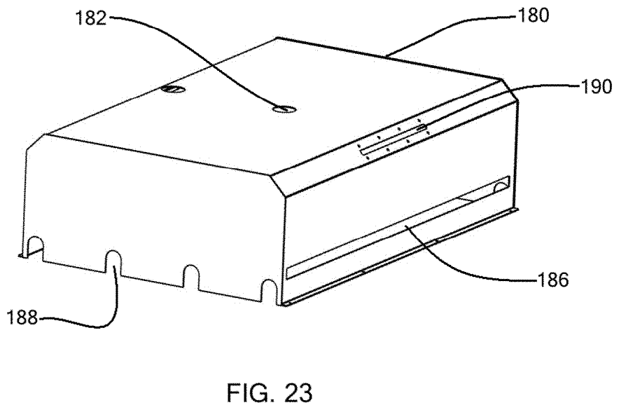

FIGS. 20 and 21 show the coating apparatus 160 with the outer chamber housing 166 removed. A central chamber housing 180 can be seen, which is nested inside the outer chamber housing 166 (see FIGS. 16 and 17). The central chamber housing 180 can include one or more central chamber connectors 184 to provide a treatment substance or a vacuum inside the central chamber housing 180. Two such central chamber connectors 184 are shown in the exemplary embodiments of FIGS. 20 and 21, where the connectors 184 are disposed at opposite ends of the central chamber housing 180, adjacent a top side thereof. Similar to the outer chamber housing 166 described above, the central chamber housing 180 can include one or more openings 182 to permit access to connectors nested inside the central chamber housing 180, as discussed below.

The central chamber housing 180 can include a slot 186 on each side thereof to permit the substrate 162 to move into and out of the interior of the central chamber housing 180. The central chamber housing 180 may further include cutouts 188 to provide space for one or more rollers or other drive elements (such as a drive belt, or the like) to guide the substrate 162 through the coating apparatus 160. A mount location 190 may be provided near a top of the central chamber housing 180 for attaching the central chamber connectors 184.

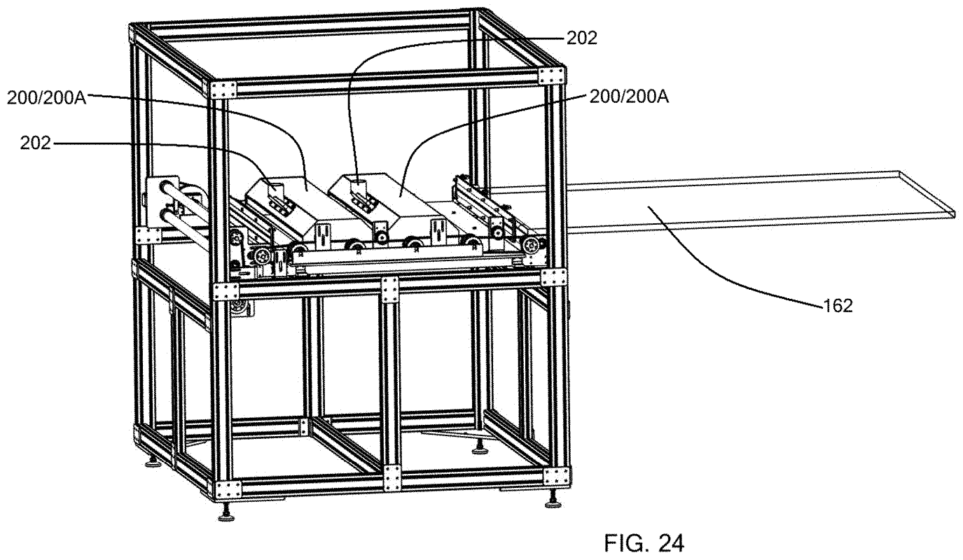

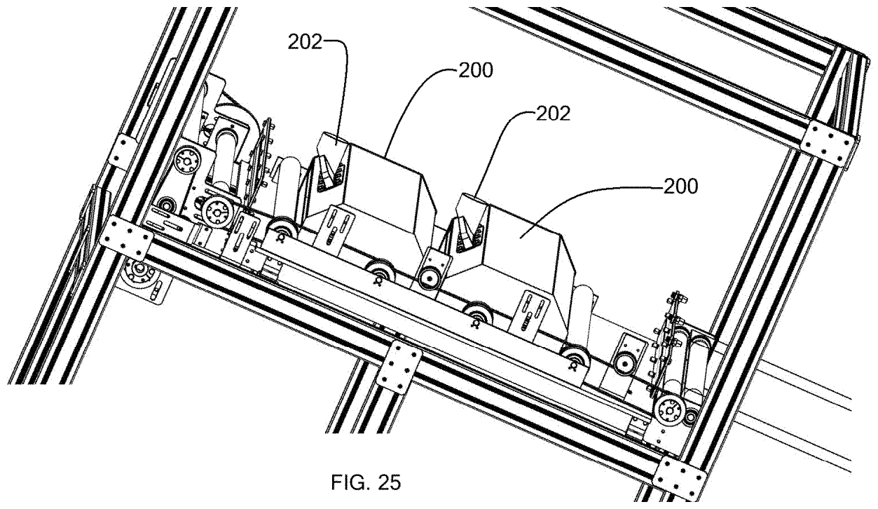

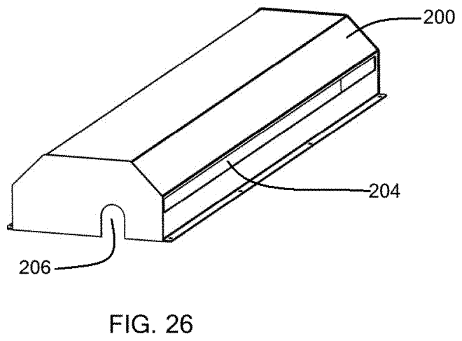

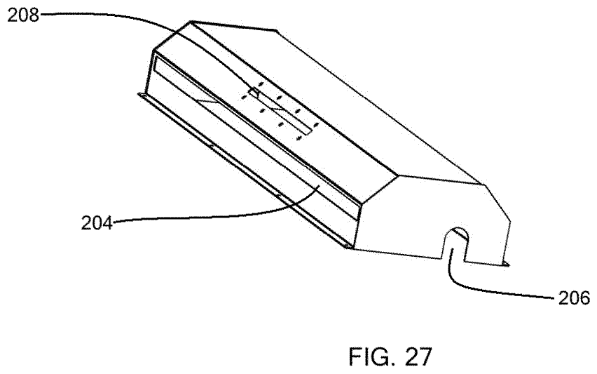

Referring now to FIGS. 24 through 27, the coating apparatus 160 is shown with the outer chamber housing 166 and the central chamber housing 180 removed. Nested inside the central chamber housing 180 is one or more inner chamber housings 200. As shown in FIGS. 24 and 25, two inner chamber housings 200 are shown. Inner chamber connectors 202 may be attached to each of the inner chamber housings 180 to provide a treatment substance inside each of the inner chamber housings 200.

The inner chamber housings 180 can each include a slot 204 on each side thereof to permit the substrate 162 to move into and out of the interior of the inner chamber housing 200. The inner chamber housing 200 may further include cutouts 206 to provide space for one or more rollers or other drive elements (such as a drive belt, or the like) to guide the substrate 162 through the coating apparatus 160. A mount location 208 may be provided near a top of each of the inner chamber housings 200 for attaching the inner chamber connectors 202.

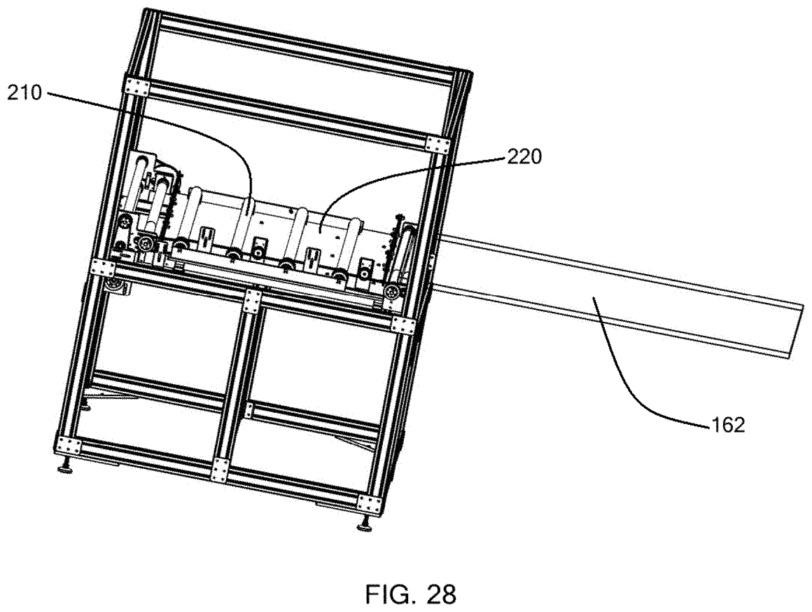

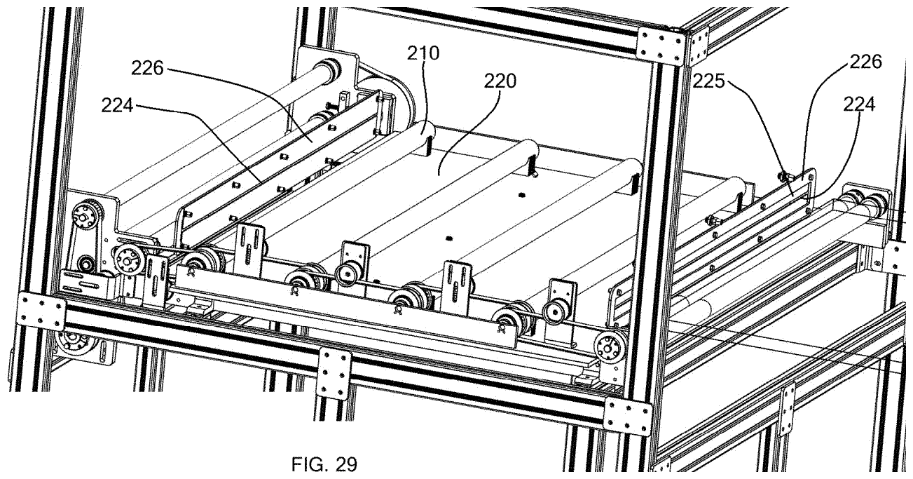

FIGS. 28 and 29 show the coating apparatus 160 with the inner chamber housings 200 removed therefrom. As can be seen, rollers 210 may be provided to guide the substrate 162 through the coating apparatus 160. The rollers 210 may be driven via belts 212 and pulleys 214, as shown, via a motor (not shown), or the rollers 210 may simply be guide rollers on which the substrate 162 passes, driven by conveyors (not shown) outside of the coating apparatus 160.

A catch pan 220 may be disposed below the rollers 210 to catch any excess treatments. One or more holes 222 in the catch pan 220 may be used to drain the excess treatment to an appropriate container.

An infeed and outfeed slots 224 may be provided at each end of the coating apparatus. These slots 224 may include an outer frame 226 that may be attached to the outer chamber housing 166, where the slots 224 align with the outer chamber slots 172. A wiping element 225, such as a flexible rubber member, may be disposed in the slots 224 such that the wiping element 225 may wipe a surface of the substrate 162 when the substrate 162 passes into or out of the coating apparatus 160.

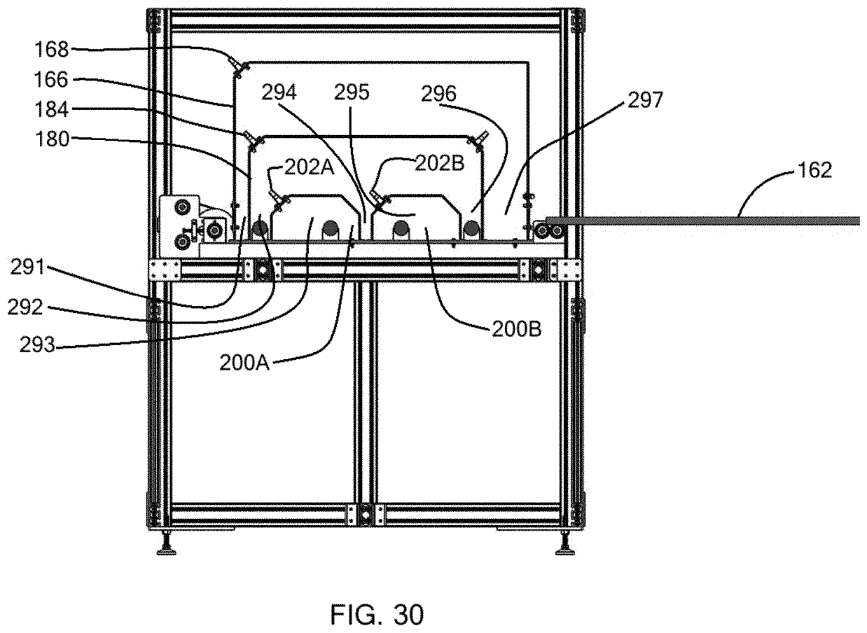

Exemplary operation of the coating apparatus 160 is described with reference to FIG. 30. The substrate 162 can pass through the coating apparatus 160 from left to right in FIG. 30, for example. As it does, it may encounter a first zone 291 which is based on an interior of the outer chamber housing 166. The size of the first zone 291 may depend on the spacing between the outer chamber housing 166 and the central chamber housing 180. In an exemplary embodiment, a vacuum may be applied at outer chamber connector 168 such that the substrate 162, at first zone 291, experiences a vacuum.

The substrate 162 may then encounter a second zone 292, which is based on an interior of the central chamber housing 180. The size of the second zone 292 may depend on the spacing between the central chamber housing 180 and the first inner chamber housing 200A. In an exemplary embodiment, water, such as mist, steam or atomized water, may be provided at the inner chamber connectors 184 such that the substrate 162, at the second zone 292, is treated with water.

The substrate 162 may then encounter a third zone 293, which is based on an interior of the first inner chamber housing 200A. In an exemplary embodiment, a first chemical treatment may be applied to the substrate 162 at the third zone 293.

The substrate 162 may then encounter a fourth zone 294, which is based on an interior of the central chamber housing 180. The size of the fourth zone 294 may depend on the spacing between the first inner chamber housing 200A and a second inner chamber housing 200B. In some embodiments, the fourth zone 294 may not be used by positioning the inner chamber housings 200A, 200B in contact with each other.

The substrate 162 may then encounter a fifth zone 295, which is based on an interior of the second inner chamber housing 200A. In an exemplary embodiment, a second chemical treatment may be applied to the substrate 162 at the fifth zone 295.

The substrate 162 may then encounter a sixth zone 296, which is based on an interior of the central chamber housing 180. The size of the sixth zone 296 may depend on the spacing between the second inner chamber housing 200B and the central chamber housing 180. In an exemplary embodiment, water, such as mist, steam or atomized water, may be provided at the inner chamber connectors 184 such that the substrate 162, at the sixth zone 296, is treated with water.

Finally, the substrate 162 may encounter a seventh zone 297, which is based on an interior of the outer chamber housing 166. The size of the seventh zone 297 may depend on the spacing between the outer chamber housing 166 and the central chamber housing 180. In an exemplary embodiment, a vacuum may be applied at outer chamber connector 168 such that the substrate 162, at seventh zone 297, experiences a vacuum.

Each of the chamber housings 160, 180, 200 may be formed as open containers with a top member, side members extending downward from the top member and terminating to define an open bottom. While the housings 160, 180, 200 are shown generally rectangular, other shapes are contemplated within the scope of the present invention.

While two inner chamber housings 200, one central chamber housing 180 and one outer chamber housing 166 are shown, the number of housings may vary depending on the particular application. Further, while three nested housing layers are shown, as few as two nested housings or more than three nested housings may be used depending on the particular application.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A coating apparatus comprising:
a substrate guide for directing a substrate through the coating apparatus;
at least one inner chamber housing having a closed top with side members extending from the closed top to terminate at an open inner chamber bottom thereof, the open inner chamber bottom positioned adjacent the substrate when the substrate passes under the at least one inner chamber housing;
at least one inner chamber connector disposed on each of the at least one inner chamber housing, the at least one inner chamber connector providing a first treatment to an interior of the inner chamber housing;
an outer chamber housing nested over all of the at least one inner chamber housing, the outer chamber housing having a closed top with side members extending from the closed top to terminate at an open outer chamber bottom thereof, the open outer chamber bottom positioned adjacent the substrate about an outer periphery of each of the at least one inner chamber housing when the substrate passes under the outer chamber housing; and
at least one outer chamber connector disposed on each of the at least one outer chamber housing, the at least one outer chamber connector providing a second treatment from outside the outer chamber housing to an interior of the outer chamber housing.

2. The coating apparatus of claim 1, wherein each of the at least one inner chamber housing and the outer chamber housing includes a slot on opposite respective side walls thereof, the slots permitting the substrate to move through the at least one inner chamber and the outer chamber.

3. The coating apparatus of claim 2, further comprising infeed and outfeed frames having a frame slot formed therein, the infeed and outfeed frames attached to the outer chamber housing such that the frame slots align with the slots on opposite side walls of the outer chamber housing.

4. The coating apparatus of claim 3, wherein the frame slots include flexible wiping elements configured to wipe a surface of the substrate as the substrate passes therethrough.

5. The coating apparatus of claim 1, further comprising:
at least one central chamber housing nested over all of the at least one inner chamber and nested inside the outer chamber housing, the central chamber housing having a closed top with side members extending from the closed top to terminate at an open central chamber bottom thereof, the open central chamber bottom positioned adjacent the substrate about an outer periphery of each of the at least one inner chamber housing when the substrate passes under the outer chamber housing; and
at least one central chamber connector disposed on each of the at least one central chamber housing, the at least one central chamber connector providing a third treatment from outside the central chamber housing to an interior of the central chamber housing.

6. The coating apparatus of claim 5, wherein the closed top of the outer chamber includes at least one through hole to provide a means to deliver the third treatment to the inner chamber connector.

7. The coating apparatus of claim 1, wherein the at least one inner chamber housing includes a first inner chamber housing and a second inner chamber housing, each nested inside the outer chamber housing and each configured to provide the same or different treatments to the substrate when the substrate passes under the open inner chamber bottom thereof.

8. The coating apparatus of claim 1, wherein the closed top of the outer chamber includes at least one through hole to provide a means to deliver the second treatment to the inner chamber connector.

9. The coating apparatus of claim 1, further comprising a frame to support the coating apparatus at a desired height.

10. A coating apparatus for applying a treatment to a substrate, comprising:
at least one inner chamber housing having a closed top with side members extending from the closed top to terminate at an open inner chamber bottom thereof, the open inner chamber bottom positioned adjacent the substrate when the substrate passes under the at least one inner chamber housing;
at least one inner chamber connector disposed on each of the at least one inner chamber housing, the at least one inner chamber connector providing a first treatment to an interior of the inner chamber housing;
at least one central chamber housing nested over all of the at least one inner chamber, the at least one central chamber having a closed top with side members extending from the closed top to terminate at an open chamber bottom thereof, the open central chamber bottom positioned adjacent the substrate about an outer periphery of each of the at least one inner chamber housing when the substrate passes under the central chamber housing;
at least one central chamber connector disposed on each of the at least one central chamber housing, the at least one central chamber connector providing a second treatment to the interior of the central chamber housing;
an outer chamber housing nested over all of the at least one central chamber housing, the outer chamber housing having a closed top with side members extending from the closed top to terminate at an open outer chamber bottom thereof, the open outer chamber bottom positioned adjacent the substrate about an outer periphery of each of the at least one central chamber housing when the substrate passes under the outer chamber housing;
at least one outer chamber connector disposed on each of the at least one outer chamber housing, the at least one outer chamber connector providing a third treatment from outside the outer chamber housing to an interior of the outer chamber housing;
a plurality of through holes in the outer chamber housing to provide a means to deliver the second treatment to the central chamber connector and to deliver the first treatment to the interior of each of the at least one inner chamber housing; and
at least one central chamber through hole in the central chamber housing to provide a means to deliver the first treatment to the interior of each of the at least one inner chamber housing.

11. The coating apparatus of claim 10, wherein the at least one inner chamber housing includes a first inner chamber housing and a second inner chamber housing, each nested inside the outer chamber housing and each configured to provide the same or different treatments to the substrate when the substrate passes under the open inner chamber bottom thereof.

12. The coating apparatus of claim 10, wherein each of the at least one inner chamber housing, each of the at least one central chamber housing and the outer chamber housing each includes a slot on opposite respective side walls thereof, the slots permitting the substrate to move through the at least one inner chamber, the at least one central chamber and the outer chamber.

13. The coating apparatus of claim 12, further comprising infeed and outfeed frames having a frame slot formed therein, the infeed and outfeed frames attached to the outer chamber housing such that the frame slots align with the slots on opposite side walls of the outer chamber housing.

14. A method of treating a substrate comprising:
passing a substrate through a first treatment zone within an outer chamber housing, the outer chamber housing having a closed top with side members extending from the closed top to terminate at an open outer chamber bottom thereof, the open outer chamber bottom positioned adjacent the substrate;
providing a first treatment within the outer chamber housing via at least one outer chamber connector disposed on the outer chamber housing;
passing the substrate through at least one inner chamber housing having a closed top with side members extending from the closed top to terminate at an open inner chamber bottom thereof, the open inner chamber bottom positioned adjacent the substrate when the substrate passes under the at least one inner chamber housing, the at least one inner chamber housing nested within the outer chamber housing; and
providing a second treatment within the at least one inner chamber housing via at least one inner chamber connector disposed on the inner chamber housing.

15. The method of claim 14, wherein each of the at least one inner chamber housing and the outer chamber housing includes a slot on opposite respective side walls thereof, the substrate moving through the slots in the at least one inner chamber and the outer chamber.

16. The Method of claim 14, further comprising:
passing the substrate through at least one central chamber housing nested over all of the at least one inner chamber and nested inside the outer chamber housing, the central chamber housing having a closed top with side members extending from the closed top to terminate at an open central chamber bottom thereof, the open central chamber bottom positioned adjacent the substrate about an outer periphery of each of the at least one inner chamber housing when the substrate passes under the outer chamber housing; and
providing a third treatment within the at least one central chamber via at least one central chamber connector disposed on each of the at least one central chamber housing.

17. The method of claim 16, further comprising passing the third treatment through at least one through opening in the closed top of the outer chamber.

18. The method of claim 16, further comprising passing the second treatment through at least one through opening in the closed top of the outer chamber and at least one through opening in the closed top of the inner chamber.

19. The method of claim 14, wherein the at least one inner chamber housing includes a first inner chamber housing and a second inner chamber housing, each nested inside the outer chamber housing and each configured to provide the same or different treatments to the substrate when the substrate passes under the open inner chamber bottom thereof.
